(19) United States
(12) Patent Application Publication
(10) Pub. No.: US 2026/0010569 A1
(43) Pub. Date: Jan. 8, 2026

(54) GENERATING RESPONSE(S) TO USER INPUT(S) FOR NEW CONVERSATION(S) BY SELECTING AND PREPENDING CONVERSATIONAL CONTEXT(S) FROM PRIOR CONVERSATION(S)

(71) Applicant: GOOGLE LLC, Mountain View, CA (US)

(72) Inventor: Dongeek Shin, San Jose, CA (US)

(21) Appl. No.: 18/763,557

(22) Filed: Jul. 3, 2024

(51) Int. Cl. G06F 16/9032; G06F 16/9038

(52) U.S. Cl. CPC G06F 16/90324; G06F 16/9038

(57) ABSTRACT

Implementations relate to utilizing machine learning model(s) in selecting a prior conversational context related to a user query in response to receiving the user query. The prior conversation context can be based on a particular prior dialog that is selected from all prior dialogs and based on the user query. The particular prior dialog can be selected based on processing at least the user query and a list of topics, respectively determined from the prior dialogs, using the machine learning model(s). For example, an output of the machine learning model(s) can indicate a particular topic from the list of topics that is related to the user query, and the particular topic can be utilized to identify the particular prior dialog from which the particular topic is determined, thereby enabling the particular prior dialog (or a representation thereof) to be utilized as context in responding to the user query.

### BACKGROUND

A user may direct a new user query towards a virtual assistant or interface that enables the user to interact with generative model(s), and vaguely remember having a previous dialog with the virtual assistant or the interface that enables the user to interact with the generative model(s) in a similar or related topic. In this case, the user may be able to search through a listing of a plurality of prior dialogs (e.g., a chat history to find the previous dialog and continue, in that conversation, with the new user query. The conventional approach for a user to continue the previous dialog relies on manual review, or search, of the chat history between the user and the virtual assistant or the interface that enables the user to interact with the generative model(s), to identify and access the previous dialog.

However, the conventional approach may consume unnecessary computational resources since the chat history may include tens of (or hundreds of) prior conversations/dialogs between the user and the virtual assistant or the interface that enables the user to interact with the generative model(s). Put another way, the user may be required to provide inputs to swipe between these prior dialogs, access one or more of these prior dialogs, go back to the chat history if the prior dialog that was accessed is not the prior dialog that the user was looking for, and so on, thereby increasing a quantity of user inputs received at a client device, unnecessarily consuming battery of the client device, etc. The unnecessary consumption of these resources can be exacerbated when the user is viewing the chat history at a client device that has a relatively limited display size (e.g., a mobile phone) since the user may only be able to view relatively fewer prior dialogs compared to other client devices that has a relatively larger display size (e.g., a laptop or desktop). Accordingly, there is a need in the art for techniques to enable quick and efficient retrieval of these prior dialogs without the user having to search through these prior dialogs via the chat history.

### SUMMARY

Various implementations disclosed herein relate to identifying or selecting a conversational context (e.g., a previous dialog having the same or related topic) associated with a user query received via a virtual assistant. Various implementations disclosed herein further relate to generating a response to the user query, using a generative model, based not only on the user query but also on the conversational context (e.g., the previous dialog identified or selected (or a representation thereof)). In various implementations, the previous dialog can be identified or selected from all previous dialogs between a user that provides the user query and the virtual assistant (or other interface that enables the user to interact with generative model(s)), for instance, using a routing agent that accesses a topic dictionary. In various implementations, the topic dictionary can include a plurality of topics each corresponding to one of the previous dialogs between the user and the virtual assistant, where the plurality of topics are determined based on processing (e.g., summarizing) the previous dialogs, respectively, e.g., using the generative model or an additional generative model trained to summarize text and/or other types of media content (e.g., image, video, etc.). In various implementations, the routing agent can include a the generative model, the additional generative model, or a further additional generative model, and a prompt including at least the user query and the topic dictionary can be processed using one or more of the aforementioned generative models, to generate a model output indicating a topic, from the plurality of topics in the topic dictionary, that is related to the user query. The model output of one or more of the aforementioned generative models can be a one-hot vector indicating the topic that is related to the user query, and based on the on-hot vector, the aforementioned previous dialog can be selected and prepended to the user query, for generation of the aforementioned response that is responsive to the user query.

In some implementations, the model output of the further generative model may not be a one-hot vector, and can be, for instance, a continuous vector listing a plurality of probabilities each indicating a likelihood that a respective topic from the topic dictionary is related to the user query. In this case, one or more topics can be determined as being related to the user query, and one or more corresponding previous dialogs can be retrieved and processed along with the user query to generate the aforementioned response. In some implementations, the one or more of the aforementioned generative models can each be a language model (e.g., large language model, “LLM”). In some implementations, the one or more of the aforementioned generative models can be different from each other, but this is not required.

In various implementations, a computer-implemented method is provided, the computer-implemented method includes: identifying a plurality of prior human-to-computer dialogs stored in association with a user; processing, using a first machine learning model, the plurality of prior human-to-computer dialogs respectively to determine a topic for each of the plurality of prior human-to-computer dialogs; and storing, in one or more databases, the topic for each of the plurality of prior human-to-computer dialogs.

In some of the various implementations, each prior human-to-computer dialog stored in association with the user can be collected from a prior human-to-computer dialog session, and can include a transcript for one or more dialog turns of the prior human-to-computer dialog session. The prior human-to-computer dialog session allows communications between the user and a virtual assistant (or other application that enables human-to-computer dialog sessions via an interface of a client device, such as a chat application, etc.). In some of the various implementations, the prior human-to-computer dialog session can be initiated, e.g., by the user (through uttering one or more hotwords, such as “Hey Assistant”, that activate the virtual assistant, through selection of an activation button that activates the virtual assistant, or through accessing a webpage or other software application, etc.). The multiple dialog turns can include, for instance, one or more dialog turns each reflecting content of a respective user input received from the user, and/or one or more additional dialog turns each reflecting content of a respective assistant input received from the virtual assistant. It is noted that the virtual assistant may also be referred to as “automated assistant,” “chatbot,” “interactive personal assistant,” “intelligent personal assistant,” “conversational agent,” etc., and the present disclosure is not limited thereto.

In some of the various implementations, each prior human-to-computer dialog can additionally include metadata associated with a context of a respective human-to-computer dialog. The metadata associated with the context of the respective human-to-computer dialog can include, for instance, a link or address to an attachment (e.g., receipt, file, etc.), an address or link to a webpage, a timestamp associated with each user input or assistant input, etc. Descriptions of the metadata, however, are not limited herein.

In some of the various implementations, the first machine learning model can be a first generative model (e.g., language model, “LM”, or large language model, “LLM”) trained or fine-tuned to process content (e.g., text, image, video, etc., or any combination thereof) to generate a topic that characterizes or summarizes the content. In some of the various implementations, optionally, the topic for each of the plurality of prior human-to-computer dialogs can be stored as a topic list and/or be included in a topic dictionary, but this is not required.

As a working example, the user may have engaged in a total number of N human-to-computer dialog sessions, where each of the N human-to-computer dialog sessions have come to an end, and where “N” is a positive integer greater than or equal to “1”. In this working example, to utilize techniques described herein, each human-to-computer dialog collected from one of the N human-to-computer dialog sessions can be processed, using the first machine learning model, to generate a corresponding topic, resulting in a total number of N topics. As a first example, the N topics can be: “sports”, “travel”, “pet”, “gardening”, “work”, etc. As another example, the N topics can be: “beer tour in park X”, “trip to SF”, “birthday dinner reservation”, “concepts in quantum mechanics”, “booking hotel in Louisville”, “endangered animals in Africa”, “home office setup”, etc. The length and/or level of granularity with respect to content in each topic generated using the first machine learning model, however, are not limited to descriptions herein.

Continuing with the working example above, and subsequent to the generation of the N topics, the user can engage in an additional human-to-computer dialog session. In this case, an additional human-to-computer dialog (e.g., the “N+1” human-to-computer dialog) can be processed, using the first machine learning model, to generate an (N+1)^{th} topic. Optionally, the (N+1)^{th} topic can be stored in the aforementioned one or more databases. Optionally, the (N+1)^{th} topic can be added to the topic list (and/or the topic dictionary), thereby updating the topic list (and/or the topic dictionary).

In various implementations, subsequent to determining the topic for each of the plurality of prior human-to-computer dialogs, the method further includes: receiving a user query via an interface of a client device; and processing, using a second machine learning model, at least the user query and the topics respectively determined for the plurality of prior human-to-computer dialogs, to generate model output that indicates whether the user query is related to a given topic from among the topics respectively determined for the plurality of prior human-to-computer dialogs. In some of the various implementations, the first machine learning model can be a generative model, and the second machine learning model can be an additional generative model having fewer parameters than the first generative model. In this case, optionally, the first machine learning model can be hosted at the server device, and the second machine learning model can be hosted at the client device. But this is not required. For example, both the first and second machine learning models can be hosted at the server device, e.g., to ensure appropriate handling/processing of complex (e.g., having both text and images, etc.) or lengthy human-to-computer dialogs. Or, both the first and second machine learning models can be hosted at the client device, to enhance the level of privacy for the user and/or to reduce possible latency associated with data transmission over one or more networks between the client device and the server device.

In some of the various implementations, the second machine learning model can be a language model. In some of the various implementations, a first prompt can be generated to include the user query and the topics respectively determined for the plurality of prior human-to-computer dialogs. The first prompt can be processed as input, using the second machine learning model, to generate the model output that indicates whether the user query is related to the aforementioned given topic.

In some of the various implementations, the first prompt can further include an instruction that instructs to generate model output indicating whether the user query is related to any topic from the topics respectively determined for the plurality of prior human-to-computer dialogs. In some of the various implementations, the instruction in the first prompt can be in natural language, and can define a format of the model output that indicates whether the user query is related to any topic from the topics respectively determined for the plurality of prior human-to-computer dialogs. For instance, the instruction can define that the model output in the form of a one-hot vector (e.g., [0, 0, 1, 0, . . . , 0], where each digit in the one-hot vector is either “0” that indicates irrelevance, or “1” that indicates a relevance, and where the total number of digits in the one-hot vector corresponds to the total number of determined topics). The instruction can define that the model output in other formats, such as a plurality of probabilities (e.g., 0.08, 0.05, 0.79, . . . , 0.01) each indicating a likelihood that the user query is related to a respective topic from the topics respectively determined for the plurality of prior human-to-computer dialogs. The format of the model output, however, is not limited to descriptions herein.

In some of the various implementations, one or more training examples can be generated and be included in the first prompt. Optionally, the one or more training examples can be generated, e.g., based on the topics respectively determined for the plurality of prior human-to-computer dialogs (which may be referred to as “topic list”). For instance, the Optionally, the one or more training examples can include a first training example that includes a first example user query (e.g., as an example model input), the topic list, and a first example model output (e.g., in the format of one-hot vector, etc.) indicating a selection of a first example topic. In this case, the first example topic is selected from the topic list based on the first example topic being related to the first example user query.

Additionally, or alternatively, the one or more training examples can include a second training example that includes a second example user query (e.g., as example model input), the topic list, and a second example model output (e.g., in the format of one-hot vector, etc.) indicating selection of a second example topic, where the second example topic is selected from the topic list based on the second example topic being related to the second example user query.

In some implementations, optionally, the one or more training examples can be generated based on an additional topic list, where the additional topic list can be different from the aforementioned topic list. The additional topic list, for instance, may not be generated using the aforementioned second machine learning model, and can include one or more topics different from the topics which are respectively determined for the plurality of prior human-to-computer dialogs.

In some implementations, continuing with the working example above, the N topics can include: “beer tour in park X”, “trip to SF”, “birthday dinner reservation”, “concepts in quantum mechanics”, “booking hotel in Louisville”, “endangered wildlife in Africa”, and “home office setup”. In this case, a user query such as “I want to learn more about Cheetah” can be received (e.g., via the virtual assistant or another interface that enables the user to interact with the generative model(s) described herein). In response to receiving such user query, the first prompt can be generated to include the user query, the N topics, the instruction to generate model output indicating whether the user query is related to any topic from the N topics, and/or one or more of the aforementioned training examples. It is noted that, due to the limited length of tokens (which can be a word, a portion of the word such as one or more characters, etc.) processable using the second machine learning model, the N topics are included in the first prompt, instead of directly including the entirety for each of the N prior human-to-computer dialog sessions in the first prompt for processing using the second machine learning model.

In some of the various implementations, the second machine learning model can be fine-tuned using one or more of the aforementioned training examples as described above. One or more weights or parameters of the second machine learning model can be fined-tuned/adjusted based on comparing (i) a model output generated from processing an example user query in the first (or second, etc.) training example with (ii) a corresponding example model output in the first (or second, etc.) training example. For instance, one or more weights or parameters of a last layer of the second machine learning model can be fine-tuned based on the comparing. In implementations where the second machine learning model is fine-tuned using the one or more training examples described above, the aforementioned one or more training examples and/or the instruction can be omitted from (i.e., not included in) the first prompt to be processed using the second machine learning model.

In various implementations, in response to determining that the user query is related to the given topic, the method further includes: causing a response to be generated based on both the user query and a given dialog, from among the plurality of prior human-to-computer dialogs, that is associated with the given topic (e.g., which is processed to determine the given topic); and causing the response to be rendered in response to the user query, as part of the new human-to-computer dialog (i.e., that includes the user query).

In some of the various implementations, the response can be generated using the first machine learning model or a third machine learning model, based on processing the user query and the given dialog. The third machine learning model can be a generative model (e.g., a large language model, “LLM”). For example, a second prompt can be generated to include the user query and the given dialog. In this example, the second prompt can be processed as input, using the third machine learning model, to generate a model output reflecting a response responsive to the user query.

In some of the various implementations, the method further includes: causing the given dialog, a link to the given dialog, or a graphical element embedded with the link to the given dialog, to be rendered with respect to the user query.

Continuing with the working example above, given the first prompt at least including the N topics (e.g., “beer tour in park X”, “trip to SF”, “birthday dinner reservation”, “concepts in quantum mechanics”, “booking hotel in Louisville”, “endangered wildlife in Africa”, and “home office setup”) and the user query (e.g., “I want to learn more about Cheetah”), a model output of the second machine learning model can indicate that the user query of “I want to learn more about Cheetah” is related to the given topic (e.g., “endangered wildlife in Africa”). In this case, based on the given topic of “endangered wildlife in Africa”, the given dialog which is from the plurality of prior human-to-computer dialogs, and which is processed to generate the given topic of “endangered wildlife in Africa” can be identified. The aforementioned second prompt can then be generated to include the user query of “I want to learn more about Cheetah” and the given dialog from which the given topic of “endangered wildlife in Africa” is determined. Such second prompt can be processed as input, using the third machine learning model, to generate the model output reflecting the response responsive to the user query. The response can be, for instance, “we previously discussed Grévy's zebra as being listed as an endangered wildlife and the plain zebra as near-endangered. Cheetahs actually hunt zebras, and are one of the fastest mammals on land . . . .”

In various implementations, in response to the output indicating that the user query is not related to any topic respectively determined for the plurality of prior human-to-computer dialogs, the method can further include: processing the user query, using the third machine learning model, to generate an alternative model output indicating an alternative response responsive to the user query; and causing the alternative response to be rendered in response to the user query. Continuing with the working example, the alternative response can be, for instance, “Cheetahs are one of the fastest mammals on land . . . .”

By leveraging one or more generative models (or other ML models), implementations described herein determine whether a user query received from a user is related to a previous dialog. This saves the computational and other resources (e.g., battery resources, etc.) that would otherwise be wasted when the user manually searches for the previous dialog that the user wants to resume. In some implementations, the routing agent can access or include a lightweight LLM, where the lightweight LLM can access the topic dictionary (or the one or more databases as described above) storing topics (or summaries) determined for each previous dialog between the user and the virtual assistant. The lightweight LLM can be utilized to process the user query, to output a one-hot vector (or other numeric vector, etc.) indicating whether the user query is related to any topic from the topic dictionary. The utilization of the routing agent in determining whether the user query is related to any topic from the topic dictionary also reduces the latency in retrieving the previous dialog related to the user query. Accordingly, techniques described herein enable quick and efficient identification of prior dialogs that can be utilized as context for new dialogs.

The preceding is presented as an overview of only some implementations disclosed herein. These and other implementations are disclosed in additional detail later in this disclosure.

Various implementations can include a non-transitory computer readable storage medium storing instructions executable by a processor to perform a method such as one or more of the methods described herein. Yet other various implementations can include a system including memory and one or more hardware processors operable to execute instructions, stored in the memory, to perform a method such as one or more of the methods described herein.

### BRIEF DESCRIPTION OF THE DRAWINGS

FIG. 1 depicts a block diagram of an example environment that demonstrates various aspects of the present disclosure, and in which some implementations disclosed herein can be implemented.

FIG. 2A illustrates an example scenario where a previous dialog related to a user query is determined and used to generate a response responsive to the user query, using techniques described in accordance with various implementations of the present disclosure.

FIG. 2B illustrates a user interface of a chat interface of an assistant application, in accordance with various implementations of the present disclosure.

FIG. 3 depicts an example of a method for generating a response in accordance with various aspects of the present disclosure.

FIG. 4 depicts another example of a method for generating a response in accordance with various aspects of the present disclosure.

FIG. 5 depicts an example architecture of a computing device, in accordance with various implementations.

### DETAILED DESCRIPTION

The following description with reference to the accompanying drawings is provided for understanding of various implementations of the present disclosure. It is appreciated that different features from different implementations may be combined with and/or exchanged for one another. In addition, those of ordinary skill in the art will recognize that various changes and modifications of the various implementations described herein can be made without departing from the scope and spirit of the present disclosure. Descriptions of well-known or repeated functions and constructions may be omitted for clarity and conciseness.

The terms and words used in the following description and claims are not limited to the bibliographical meanings, and are merely used to enable a clear and consistent understanding of the present disclosure. Accordingly, it should be apparent to those skilled in the art that the following description of various embodiments of the present disclosure is provided for the purpose of illustration only and not for the purpose of limiting the present disclosure as defined by the appended claims and their equivalents.

In some implementations disclosed herein, techniques can leverage a first LLM (or other type of machine learning model) to process each previous dialog (e.g., “prior human-to-computer dialog”) between a user and a virtual assistant (or interface that enables a user to interact with generative model(s)), in generating a topic that is representative of a respective previous dialog. In some implementations, the topics generated based on processing all previous dialogs between the user and the virtual assistant can be stored in a topic list or other structured manner. For instance, in some implementations, a topic dictionary can be generated to include a plurality of entries, where each entry of the topic dictionary can include a respective topic and/or a previous dialog from which the respective topic is generated (e.g., using the first LLM).

Subsequently, when a user provides a user query, techniques can leverage a routing agent (e.g., a second LLM, which can be the same as the first LLM, or a disparate LLM that is a smaller LLM than the first LLM to reduce latency) to determine whether the user query is related to any topic from the topics determined from previous dialogs between the user and the virtual assistant (or the interface that enables a user to interact with the generative model(s)). For instance, the second LLM corresponding to the routing agent can process the user query and the topics (e.g., respectively determined from the previous dialogs, which may also be referred to as “prior human-to-computer dialogs”, to generate a model output indicating whether the user query is related to a particular topic from the topics. The model output can be, for instance, a one-hot vector, a continuous vector, a plurality of probabilities, a label, or other indication that indicates whether the user query is related to any topic (e.g., from the topics determined from the previous dialogs).

In some implementations, the topics determined from the previous dialogs can be stored in a topic dictionary. As a non-limiting example, the topic dictionary can include a first entry (“entry_1”) having topic_1 (e.g., football) determined from previous dialog_1, a second entry (“entry_2”) having topic_2 (e.g., endangered wildlife in Africa) determined from previous dialog_2, and a third entry (“entry_3”) having topic_3 (e.g., home office setup) determined from previous dialog_3. Given a particular user query such as “I want to learn more about Cheetah”, the output of the routing agent (e.g., the second LLM) can be a one-hot vector, such as [0,1,0], a continuous vector, such as [0.1, 0.8, 0.1], or other vector representation, which indicates that the particular user query matches topic_2. In this example, the previous dialog_2 (or the topic 2) can be retrieved. To generate a response responsive to the particular user query, the previous dialog_2 (or a summarization of the previous dialog_2, or the topic 2) can be processed along with the particular user query, using the a third LLM (or other machine learning model), to generate a response that is responsive to the particular user query.

Optionally, when or shortly after a new conversation that started with the particular user query ends, the previous dialog_2 can be updated to include the new conversation that starts with the particular user query, and topic_2 can be updated accordingly in the second entry of the topic dictionary, for subsequent matching. Alternatively, instead of updating the previous dialog_2, the new conversation can be stored as an additional previous dialog. For instance, the new conversation that starts with the particular user query can be processed, e.g., using the first LLM, to generate a new topic (e.g., topic_4) for the new conversation. In this case, a fourth entry (“entry_4”) can be generated in the topic dictionary to store the new topic (e.g., as “topic_4”) and to store the new conversation (e.g., as “previous log_4”), thereby updating the topic dictionary. The updated topic dictionary can then be utilized to generate response(s) for subsequent user queries (if any).

By utilizing one or more machine learning models as described in the present disclosure, consumption of computational resources and latency and that are associated with generating a response responsive to a user query and that would otherwise be wasted when the user manually searches for a related previous dialog that the user wants to resume, can be reduced. The disclosed routing agent can access a lightweight LLM or other machine learning model (e.g., a classifier), where the lightweight LLM can access a topic list listing topics (or dialog summaries) respectively determined from all previous dialogs. The lightweight LLM can be utilized to process the user query, to output an indication indicating whether the user query is related to (e.g., matches) any topic from the topic list (which can be part of the topic dictionary, or can be a list simply listing all the determined topics). The utilization of the routing agent in determining whether the user query is related to (e.g., matches) any topic from the topics determined from previous dialogs also reduces the latency in retrieving a previous dialog having a topic that is related to the user query.

As used herein, each of the prior dialogs can be separated by passage of time between dialog sessions; change of context between the prior dialogs (e.g., user context or device content, such as location); detecting intervening action(s) between the user and the client device in which the user engaged in the prior dialogs; a client device, that is utilized in conducting the prior dialogs being placed in a lock/sleep mode; change of client device(s) utilized in conducting the prior dialogs; and/or based on other factors or considerations described herein.

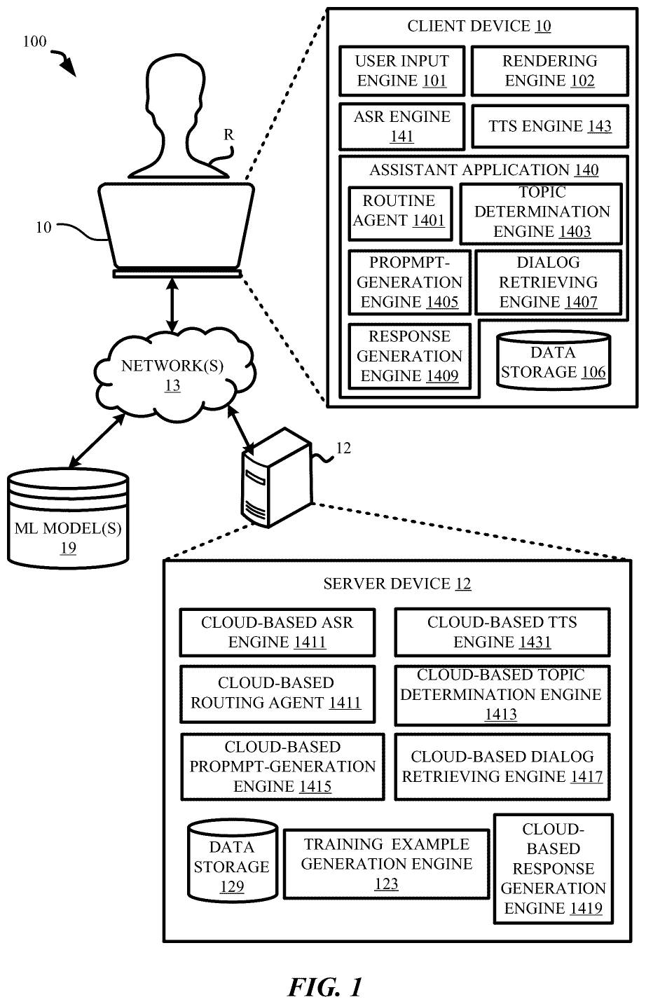

FIG. 1 is a block diagram of an example environment 100 that demonstrates various aspects of the present disclosure, and in which implementations disclosed herein may be implemented. As shown in FIG. 1, the environment 100 can include a client computing device 10 (“client device”) that is in communication with a server computing device 12 (“server device”). The client computing device 10 can be in communication with the server computing device 12, via one or more networks 13. The one or more networks 13 can include, for example, a local area network (LAN), a wide area network (WAN) such as the Internet, and/or any other appropriate network(s). In some implementations, the client computing device 10 (and/or the server computing device 12) can be in communication with one or more machine learning (ML) models 19, via the one or more networks 13.

In some implementations, the environment 100 can be an office environment, a home environment, a lab environment, a computational environment, or any other applicable environment, and the environment 10 can include additional client device(s) (or additional server device(s)) that connect to the one or more networks 13. In some implementations, the client computing device 10 can be, for example, a desktop computing device, a laptop computing device, a tablet computing device, a mobile phone computing device, a computing device of a vehicle (e.g., an in-vehicle entertainment system), a smart appliance (e.g., an interactive speaker), and/or a wearable apparatus that includes a computing device (e.g., glasses having a computing device, a smart watch, a virtual or augmented reality computing device), and the present disclosure is not limited thereto.

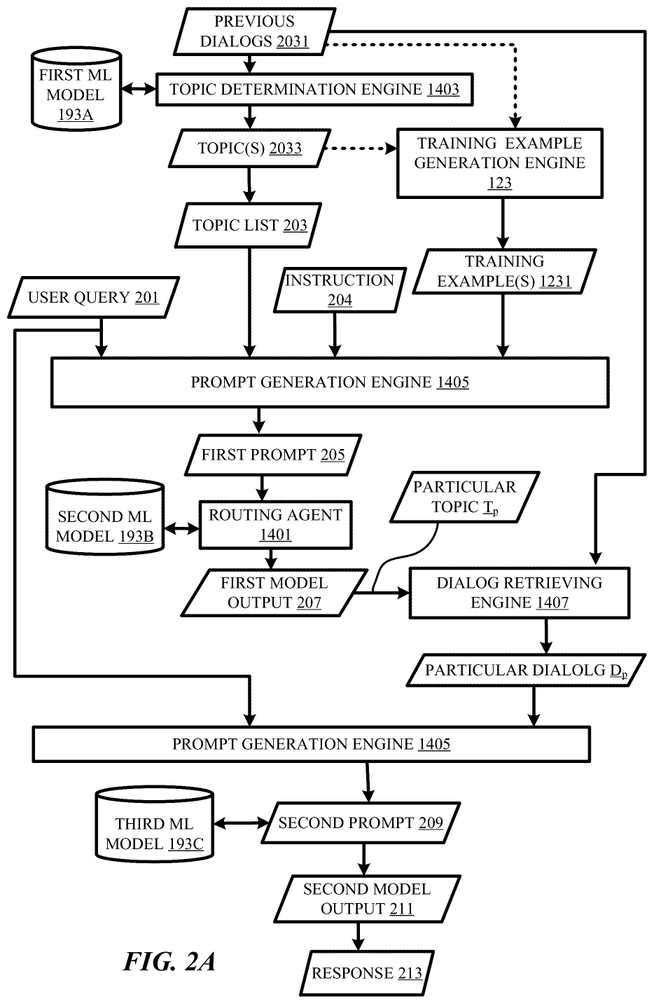

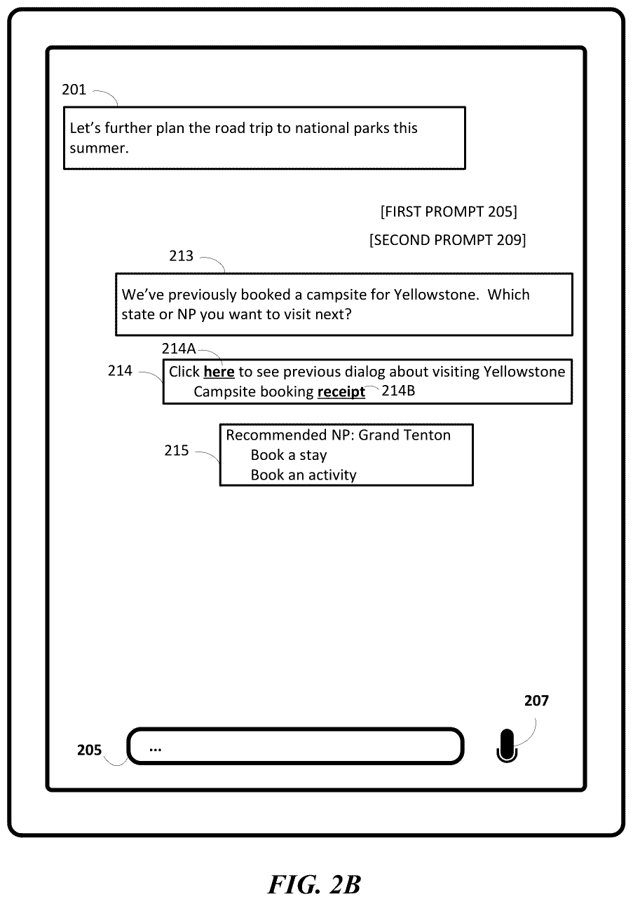

In various implementations, the client computing device 10 can include a user input engine 101 that is configured to detect user input provided by a user (e.g., user R) of the client computing device 10. The user input may be provided by the user using one or more user interface input devices, such as a keyboard, a touch screen, a vision component, a microphone, etc. The user input can be typed input, touch input, audible input, vision input, or any other applicable type of input. For example, the client computing device 10 can be equipped with a keyboard to receive typed input, and/or a mouse (or one or more hardware buttons) to receive a user click that selects one or more graphical user interface (GUI) elements that is rendered visually at a user interface of the client computing device 10. The typed input (e.g., “help me learn more about public speaking skills”) can be received, for instance, via an input field (e.g., 205 in FIG. 2B) of a graphical user interface (GUI) of an application. Additionally, or alternatively, the client computing device 10 can be equipped with one or more microphones that capture audio data, such as audio data capturing spoken utterances (“Any new movie for me to watch in the theater this weekend?”) of the user and/or other sounds in a surrounding environment of the client computing device 10. Optionally, the audio data capturing the spoken utterances can be received in response to a user selecting an icon (e.g., 207 in FIG. 2B) indicating capturing/recording of audio data. Additionally, or alternatively, the client computing device 10 can be equipped with one or more vision components that are configured to capture vision data corresponding to images and/or movements (e.g., gestures) detected in a field of view of one or more of the vision components. Additionally, or alternatively, the client computing device 10 can be equipped with one or more touch sensitive components (e.g., a stylus, a touch screen, a touch panel, etc.) that are configured to capture signal(s) corresponding to touch input that is directed to the client computing device 10.

In various implementations, the client computing device 10 can include a rendering engine 102, and/or a data storage 106. In various implementations, the rendering engine 102 can be configured to provide content for audible and/or visual presentation to a user of the client computing device 10 using one or more user interface output devices. For example, the client computing device 10 can be equipped with one or more speakers that enable content (e.g., a notification sound) to be provided for audible presentation to the user via the client computing device 10. Additionally, or alternatively, the client computing device 10 can be equipped with a display or projector that enables content (e.g., “You previously expressed an interest in watching more documentary films. Movie A was recently released and is rated as a top mountaineering documentary. Theater B nearby is now offering this movie both Saturday and Sunday night between 7:00 pm to 10:00 pm”) to be provided for visual presentation to the user via the client computing device 10.

The data storage 106, and/or a data storage 129 at the server device 12, can store various types of files, folders, and/or other data. For instance, the data storage 106 of the client computing device 10 can store metadata associated with the client computing device 10, associated with the user (e.g., a user profile of user R, etc.), and/or associated with one or more applications stored at or accessible via the client computing device 10. Additionally, or alternatively, in some implementations, the data storage 106 (or the data storage 129) can store one or more topic lists and/or one or more topic dictionaries. In some implementations, each topic list or topic dictionary can be stored in association with a respective user (e.g., a user account of the user for the assistant application 140, which may also be referred to as “virtual assistant”), which will be described in more detail later in this disclosure. Additionally, or alternatively, in some implementations, the data storage 106 (or the data storage 129) can store a plurality of training examples to train or fine-tune one or more of the ML models 19. In this case, one or more weights or parameters of the one or more ML models 19 can be adjusted or fine-tuned based on processing of the plurality of training examples.

In some implementations, alternatively, one or more of the training examples can be included, along with the user query and the topic list, in a prompt, where the prompt can be processed, e.g., by the routing agent (e.g., corresponding to the second LLM), to determine whether a user query is related to any topic determined (e.g., summarized or otherwise) from previous dialogs between the user and the assistant application 140. In this case, the one or more weights or parameters of the one or more ML models 19 may not need to be adjusted or fine-tuned. In some implementations, the ML model(s) 19 can include one or more generative models. The generative models can be, respectively, a large language model (“LLM”). In some implementations, the plurality of training examples can be generated by a training instance generation engine 123, which will be described in more detail later in this disclosure.

In some implementations, training (or fine tuning) of one or more of the generative models 19 (e.g., the first, second, or third LLM) can be performed through supervised learning, in-context learning (e.g., by including one or more training examples in a prompt, as described above), and/or reinforcement learning. The reinforcement learning can be, for instance, reinforcement learning from human feedback (“RLHF”) that incorporates human feedback into the training or fine-tuning of the LLM (e.g., the third LLM) to align output of the LLM with human preferences. This can be implemented using a reward model trained based on human feedback. For instance, for a given user input and a plurality of responses responsive to the given user input, a human reviewer can indicate a preference (e.g., in the form of a scalar score or other representation) for each of the plurality of responses. In other words, the plurality of response for the given user input can be ranked in an order from highest human preference (indicated by a highest scalar score) to lowest human preference (indicated by a lowest scalar score). In some implementations, the scalar scores assigned by the human reviewer to the plurality of responses for the given user input can satisfy a Gaussian distribution with an average value of approximately “0”, where the scalar score(s) for response(s) of higher human preference should be positive and increase with the increasing of human preference and the scalar score(s) for response(s) of lower human preference should be negative and decreases with the decreasing of human preference.

The scalar score (or other representation) can be applied as a reward in the RLHF process, where a large value of the scalar score indicates a higher quality of a corresponding response more preferred by the human reviewer and a lower value of the scalar score indicates a higher quality of a corresponding response that is less preferred by the human reviewer. In some implementations, such given user input and the plurality of responses responsive to the given user input can be stored in the data storage 106 (or the storage 129) as one instance for training the reward model. In some implementations, a small quantity of instances can be manually curated and/or stored in the data storage 106 (or 129), to train the reward model.

In various implementations, the aforementioned one or more applications accessible via the client computing device 10 can include an assistant application 140 that provides one or more functions to a user. For instance, the assistant application 140 can include a chat interface (e.g., graphical, audible, etc.) that enables human-to-computer dialogs between the assistant application 140 and one or more users. In various implementations, the assistant application 140 can include, or otherwise access, a routing agent 1401, a topic determination engine 1403, a prompt-generation engine 1405, a dialog retrieving engine 1407, and/or a response generation engine 1409. Additionally, or alternatively, the routing agent 1401, the topic determination engine 1403, the prompt-generation engine 1405, the dialog retrieving engine 1407, and/or the response generation engine 1409 can be accessed at the server computing device 12. For example, in some implementations, the routing agent 1401, the topic determination engine 1403, the prompt-generation engine 1405, the dialog retrieving engine 1407, and/or the response generation engine 1409 can be locally installed at the client computing device 10 and have counterpart (e.g., 1411, 1413, 1415, 1417, 1419) at the server computing device 12. Although the disclosure describes dialogs between the user and the assistant application 140, it should be understood that is for the sake of example and is not meant to be liming. For instance, additionally, or alternatively, the user can engage in the dialogs via a generative content application, web browser, plugin, side-panel, etc. that is in addition to, or separate from, a virtual assistant.

In some implementations, the topic determination engine 1403 can determine a plurality of topics from a plurality of human-to-computer dialogs and/or can generate a topic list (and/or a topic dictionary) that stores the plurality of topics determined from the plurality of human-to-computer dialogs. In various implementations, the topic list (or the topic dictionary) can be stored in association with a user account of the assistant application 140. In this case, a first topic list (or a first topic dictionary) associated with a first user account (e.g., by a first user) of the assistant application 140 can store a first set of topics determined from a set of human-to-computer dialog between the assistant application 140 and the first user. A second topic list (or a second topic dictionary) associated with a second user account (e.g., by a second user) of the assistant application 140 can store a second set of topics determined from a set of human-to-computer dialog between the assistant application 140 and the second user. The first user account can be different from the second user account, and correspondingly, the second topic list (or the second topic dictionary) can be different from the first topic list (or the second topic dictionary). Accordingly, the first set of topics stored in the first topic list can be different from the second set of topics stored in the second topic list.

In various implementations, the plurality of topics can be determined based on processing the plurality of human-to-computer dialogs using a first machine learning (ML) model (e.g., 193A in FIG. 2A), where the first ML model can be a first generative model trained to generate a topic for a dialog. For example, each of the plurality of human-to-computer dialogs can be processed as input, using the first generative model, to generate a respective model output from which a respective topic is derived. In some implementations, a dialog can include multimodal media content (e.g., text, image, etc.), and the first ML model can be, for instance, a multimodal generative model, or a generative model augmented by one or more image processing models (e.g., image-captioning model, etc.). The present disclosure is not limited thereto.

In various implementations, a user query from a user can be received at the assistant application 140. In this case, the routing agent 1401 can process the user query (e.g., using a second ML model, see 193B in FIG. 2A) and/or the topic list to determine whether the user query is related to any topic from the topic list (or from the topic dictionary that includes the topic list) associated with a user account of the user for the assistant application 140.

In some implementations, the second ML model can be a language model trained to generate a model output (e.g., one-hot vector, a continuous vector, or other representation) indicating whether a user query is related to any topic. In some implementations, the language model can be trained or fine-tuned via few-shot learning or in-context learning (e.g., few-shot prompting). Few-shot learning is a method that effectively trains, e.g., a neural network model, with a small amount of data. Few-shot learning alleviates the need to collect a large amount of data which may not be available within a short period of time, in situations, e.g., where a particular user just started using the assistant application 140 so that there are insufficient human-to-computer dialogs between the particular user and the assistant application 140.

For instance, given a relatively new user account of the assistant application 140, there may be only a few dialogs (e.g., a first dialog, a second dialog, and a third dialog) between a user of the relatively new user account and the assistant application 140. In this case, the training instance generation engine 123 can generate a limited number of training examples based on the few dialogs. The limited number of training examples can be labeled and be included in a first prompt, to be processed using the language model of the routing agent 1401. In some implementations, as a non-limiting example, the first prompt can include, in addition to the training examples, an instruction that instructs the language model to generate a model output indicating whether a user query is related to any topic associated with the few dialogs (e.g., the first, second, and third dialogs). It is noted that, as the interaction between the user of the relatively new user account and the assistant application 140 continues, the topic list collecting topics determined from dialogs (between the user and the assistant application 140) can be updated with additional topics that are determined from recent dialogs (between the user and the assistant application 140). The language model of the assistant application 140 can, given a user query, generate a model output (e.g., a one-hot vector a continuous vector, or other representation) indicating whether the user query is related to any topic in the topic list that is generated or updated based on all dialogs between the user of the relatively new user account and the assistant application 140 prior to receiving the user query.

In various implementations, the first ML model and the second ML model can include a transformer model that includes encoders-decoders, encoders-only, and/or decoders-only. In some of the various implementations, the second ML model and the first ML model can have slightly different weights. Descriptions of the first and second ML models, however, are not limited herein.

In various implementations, the response generation engine 1409 can generate a response to a user query based on processing the user query and one or more dialogs determined as being related to the user query. For instance, the response generation engine 1409 can generate a second prompt that includes the user query and the one or more dialogs. The second prompt can be processed using a third ML model (e.g., generative model 193C in FIG. 2A, which can be an LLM), to generate a model output reflecting the response to the user query.

In some of the various implementations, optionally, in response to the routing agent 1401 determining that the user query of the user is related to a particular topic summarized from a previous dialog between the user and the assistant application 140, the assistant application 140 can cause a link (or a graphical element embedded with the link, see 214A in FIG. 2B) to the previous dialog to be rendered with respect to (e.g., below) the user query, e.g., at a user interface of the assistant application 140.

In various implementations, a generative model (e.g., 193C, 193B, 193A, etc.) can be a large language model (LLM) having less than 100 billion parameters, more than 100 billion parameters, or over 200 billion parameters, etc. The greater the number of parameters of an LLM, the more complex (or sophisticated) a task (e.g., specified in a user query or request) the LLM can theoretically handle. The LLM may be stored at the client computing device 10, or at the server computing device 12. For instance, if the memory of the client computing device 10 restricts the storing of the LLM at the client computing device 10 or if a length of a textual prompt to be processed using the LLM exceeds a predetermined token length, the LLM may be stored at the server device 12. For instance, if the memory of the client computing device 10 does not restrict the storing of the LLM at the client computing device 10, the LLM may be stored at the client computing device 10, to reduce a latency in completing a task (e.g., specified in the user query or request), for instance, by avoiding data communications via the one or more networks 13.

In some implementations, when the generative model (e.g., 193A, 193B, 193C, etc.) is stored at the client computing device 10, the maximum token length of content (e.g., text) processable using the LLM may be a first maximum token length (e.g., 10,000). In some implementations, when the generative model is stored at the server device 12, the maximum token length of content (e.g., text) processable using the generative model may be a second maximum token length (e.g., 30,000 or upwards of several million tokens) that is greater than the first maximum token length. The maximum token length can be a maximum number of tokens that is allowed for processing, in a single iteration, using the generative model.

In some implementations, the generative model can be a transformer-based LLM. One non-limiting example of such LLM is GOOGLE'S Pathways Language Model (PaLM). Another non-limiting example of such LLM is GOOGLE'S Language Model for Dialog Applications (LaMDA), GOOGLE'S Gemini family of models.

In some implementations, the one or more applications installed at the client computing device 10 can additionally, or alternatively, include a social media application, a video player, a search application, a note-taking application, a shopping application, a messaging application, and/or any other appropriate applications (or services) installed at, or accessible via, the client computing device 10.

In various implementations, the server computing device 12 can be, for example, a web server, one or more blade servers acting together to provide “cloud” infrastructure, or any other type of server as needed. In various implementations, the server computing device 12 can include cloud-based components the same as or similar to the plurality of local components installed at the client computing device 10.

In some implementations, the server computing device 12 can further include a training instance generation engine 123. The training instance generation engine 123 can be applied to generate training examples/instances to train, fine-tune, or prompt one or more of the generative models 19, and/or to generate instances to train (or fine-tune) the aforementioned reward model. As described above, the generative model can be trained or fine-tuned, e.g., via few-shot learning, in-context learning, or reinforcement learning.

In some implementations, the client computing device 10 (or the assistant application 140) can include an automatic speech recognition (ASR) engine 141, and/or a text-to-speech (TTS) engine 143. The automatic speech recognition (ASR) engine 141, and/or a text-to-speech (TTS) engine 143 can have counterparts (e.g., 1411, 1431) accessible via the server computing device 12.

In some implementations, the ASR engine 141 (and/or a cloud-based ASR engine 1411) can process, using one or more streaming ASR models (e.g., a recurrent neural network (RNN) model, a transformer model, and/or any other type of ML model capable of performing ASR), streams of audio data that capture spoken utterances, to generate corresponding streams of ASR output. The ML model(s) can be on-device ML models that are stored locally at the client computing device 10, remote ML models that are executed remotely from the server computing device (e.g., at remote server device 12), or shared ML models that are accessible to both the client computing device 10 and/or remote systems (e.g., the remote server computing device 12). The audio data can be acquired from audio recordings or can be generated by microphone(s) of the client computing device 10. Notably, the streaming ASR model can be utilized to generate the corresponding streams of ASR output as the streams of audio data are generated.

In some implementations, the corresponding streams of ASR output can include, for example, streams of ASR hypotheses (e.g., term hypotheses and/or transcription hypotheses) that are predicted to correspond to spoken utterance(s) of a user that are captured in the corresponding streams of audio data, one or more corresponding predicted measures (e.g., probabilities, log likelihoods, and/or other values) for each of the ASR hypotheses included in the streams of ASR hypotheses, a plurality of phonemes that are predicted to correspond to spoken utterance(s) of a user that are captured in the corresponding streams of audio data, and/or other ASR output. In some versions of those implementations, the ASR engine 141 can select one or more of the ASR hypotheses as corresponding recognized text (“transcript”) that corresponds to the spoken utterance(s) (e.g., selected based on the corresponding predicted measures). The TTS engine 143 (and/or 1431) can be utilized to process text content, to generate audible data capturing the text content. The audible data can be rendered, e.g., using one or more speakers of the client computing device 10.

FIG. 2A illustrates an example scenario where a previous dialog related to a user query is determined and used to generate a response responsive to the user query, using techniques described in accordance with various implementations of the present disclosure. As shown in FIG. 2A, a client device (e.g., 10 in FIG. 1) may receive a user query 201 from a user. In some implementations, the user query 201 can be a typed input received from the user at a graphical user interface of the assistant application 140 (e.g., via keyboard, touch screen, etc.). In some implementations, the user query 201 can be a transcript of a spoken input received from the user at an audible user interface of the assistant application 140 (e.g., via one or more microphones).

In response to receiving the user query 201, the assistant application 140 can retrieve a topic list 203 (or a topic dictionary) associated with a user account of the user for the assistant application 140. The topic list 203 can include a plurality of topics 2033 generated using the topic determination engine 1403, and can be specific to the user. The plurality of topics 2033 can be generated based on respectively processing previous dialogs 2031 (e.g., all previous dialogs prior to receiving the user query 201) between the user and the assistant application 140, e.g., using a first ML model 193A. In other words, the topic determination engine 1403 can determine a plurality of topics given all dialogs between each user and the assistant application 140, and/or generate a respective topic list (or a respective topic dictionary) for each user of the assistant application 140. The respective topic list (or the respective topic dictionary) can include the plurality of topics summarized from all previous dialogs between a respective user and the assistant application 140. Optionally, the topic dictionary for a specific user can include the topic list listing all topics determined from previous dialogs between the specific user and the assistant application 140, and/or can include a mapping relationship between a respective topic in the topic list and a corresponding previous dialog used to generate the respective topic.

In some implementations, the assistant application 140 can include the prompt-generation engine 1405 that generates a first prompt 205 based on the user query 201 and the topic list 203. For example, the prompt-generation engine 1405 can generate the first prompt 205 to include the user query 201, the topic list 203, and an instruction 204. In some implementations, the instruction 204 can include content that defines a format of model output generated based on processing the user query 201 and/or the topic list 203. For instance, the instruction 204 can define the format of the model output to be a one-hot vector (e.g., [0,1,0]) or a continuous vector (e.g., [0.1, 0.8, 0.1]), etc. In some implementations, the first prompt 205 can additionally or alternatively include one or more training examples 1231. The one or more training example 1231 can include, for instance, a first training example. The first training example can include the topic list 203 (a first subset of topics from the topic list 203, or a distinct topic list determined not using the previous dialogs 2031), a first example user query, and a first example model output (e.g., a first example one-hot vector) indicating selection of a first topic from the topic list 203 (or the first subset of topics) as being related to the first example user query.

The one or more training example 1231 can additionally, or alternatively, include, for instance, a second training example. The second training example can include the topic list 203 (or a second subset of topics from the topic list 203, or a distinct topic list determined not using the previous dialogs 2031), a second example user query, and a second example model output (e.g., a second example one-hot vector) indicating selection of a second topic from the topic list 203 (or from the second subset of topics) as being related to the second example user query.

In some implementations, the first subset of topics is the same as the second subset of topics. In this case, the first example user query can be different from the second example user query. In some implementations, the first subset of topics is different from the second subset of topics. For instance, the second subset of topics can include one or more topics, in addition to the first subset of topics. In this case, the first example user query can be the same as, or different from, the second example user query.

The first prompt 205 can be processed, using a second ML model 193B, to generate a first model output 207 indicating a particular topic Tₚ from the topic list 203 that is related to the user query 201. In some implementations, the assistant application 140 can include a dialog retrieving engine 1407 that retrieves a particular previous dialog Dₚ (or a representation of the particular previous dialog Dₚ that is of a reduced token size relative to the entirety of the particular previous dialog Dₚ) based on the first model output 207 which indicates the particular topic Tₚ, where the particular topic Tₚ is determined by processing (e.g., summarizing) the particular previous dialog Dₚ. In some implementations, the prompt-generation engine 1405 can generate a second prompt 209 based on the first model output 207. The prompt-generation engine 1405 can generate the second prompt 209 to include the user query 201 and the particular previous dialog Dₚ. The second prompt 209 can be processed as input, using a third ML model 193C, to generate a second model output 211 reflecting a response 213 responsive to the user query 201. The response 213 can be rendered to the user, in response to the user query 201, via the assistant application 140.

Optionally, in some implementations, the particular previous dialog Dₚ, once retrieved, can be rendered visually with respect to the user query 201. For instance, a link (or a GUI element) to the particular previous dialog Dₚ can be rendered with respect to the user query 201. The link (or the GUI element) can be selectable, and when selected, can cause the particular previous dialog Dₚ (or a portion thereof) to be rendered (e.g., via a pop-up window, etc.).

FIG. 2B illustrates a user interface of a chat interface of an assistant application (or generative content application or web browser landing page that enables a user to interact with generative model(s)), in accordance with various implementations of the present disclosure. As a non-limiting example shown in FIG. 2B, the user query 201 can be, for instance, “Let's further plan the road trip to national parks this summer”. The user query 201 can be received from a user (e.g., user R in FIG. 1), and in response to receiving the user query 201, the first prompt 205 can be generated, where the first prompt 205 can include the user query 201, and the topic list 203 that includes, e.g., a first topic of “sports”, a second topic of “summer road trip”, a third topic of “cooking”, . . . , and a fourth topic of “physics”. Optionally, the first prompt 205 can further include a first instruction that instructs the second ML model 193B, to generate the first model output 207 (e.g., a one-hot vector) indicating whether the first query 201 is related to any of the N topics in the topic list 203.

As a non-limiting example, the first prompt 205 can be:
“Given the user query below, determine whether the user query is related to any topic listed in the topic list.
User query: Let's further plan the road trip to national parks this summer
Topic list: sports, summer road trip, cooking, physics”
   In the above example, the first model output 207 can be, for instance, a first probability of about 0.1 for the topic “sports” indicating a low likelihood that the user query is related to the topic “sports”, a second probability of about “0.9” for the topic “summer road trip” indicating a high likelihood (e.g., satisfying a likelihood threshold) that the user query is related to the topic “sports”, a third probability of about “0” for the topic “cooking” indicating a low likelihood that the user query is related to the topic “cooking” and a fourth probability of about “0” for the topic “physics” indicating a low likelihood that the user query is related to the topic “physics”. Alternatively, the first model output 207 can be, for instance, a label of “summer road trip”.

As another non-limiting example, the first prompt 205 can be:
“USER QUERY 1: when is the dog swim day?
TOPIC LIST 1: pet, physics, housekeeping
OUTPUT: [1 0 0]
USER QUERY 2: how many rains will we have for the next week while I am away? I may need to install an irrigation system if there will be little rain.
TOPIC LIST 2: sports, gardening, sports
OUTPUT: [0 1 0]
USER QUERY: Let's further plan the road trip to national parks this summer
TOPIC LIST: sports, summer road trip, cooking, physics
OUTPUT:”
   In the above example, the first model output 207 can be, for instance, a one-hot vector of [0 1 0 0] which indicates that the user query of “Let's further plan the road trip to national parks this summer” is related to the topic “summer road trip”.

As a further non-limiting example, the first prompt 205 can be:
“USER QUERY 1: when is the dog swim day?
TOPIC LIST 1: pet, physics, housekeeping
OUTPUT: [0.99, 0, 0.01]
USER QUERY 2: how many rains will we have for the next week while I am away? I may need to install an irrigation system if there will be little rain.
TOPIC LIST 2: sports, gardening, sports
OUTPUT: [0, 0.9, 0.1]
USER QUERY: Let's further plan the road trip to national parks this summer
TOPIC LIST: sports, summer road trip, cooking, physics
OUTPUT:”

In the above example, the first model output 207 can be, for instance, a continuous vector of [0.1, 0.8, 0.1, 0] which indicates that the user query of “Let's further plan the road trip to national parks this summer” is related to the topic “summer road trip”.

It is noted that, content of the first prompt 205, however, is not limited to examples provided above. It is noted that, while the first prompt 205 is illustrated in FIG. 2B as being generated in response to the user query 201, the first prompt 205 is in fact not rendered to the user via the interface 200, but is provided to the second ML model 193B, for processing using the second ML model 193B.

As described above and continuing with the example in FIG. 2A, the first model output 207 (e.g., a one-hot vector, a continuous vector, etc.) can indicate that the user query 201 is related to the particular topic Tₚ of “summer road trip”. The particular topic Tₚ of “summer road trip” can be determined (e.g., summarized) from a particular dialog Dₚ for a prior human-to-computer dialog session between the user and the assistant application 140. The particular dialog Dₚ, for instance, can include user input(s) from the user and assistant input(s) from the assistant application 140 that related to a first stop (e.g., Yellowstone National Park) already planned for the summer road trip.

The second prompt 209 can be generated to include the user query 201 and the particular previous dialog Dₚ. The second prompt 209 can be processed to generate the response 213. The response 213 can be, for instance, “We've previously booked campsites for Yellowstone. Which state or NP you want to visit next?” Optionally, depending on the training or fine-tuning of the third ML model 193C (see FIG. 2A), the response 213 can further include a first follow-up message 214. The first follow-up message 214 can include content, such as “Click here to see previous dialog about visiting Yellowstone”. The content (or a portion thereof) of the first follow-up message 214 can be embedded with a link 214A, where the link 214A can be selectable, and when selected, causes the particular previous dialog Dₚ to be rendered via the interface 200. The first follow-up message 214 can further include, for instance, additional context information associated with the particular previous dialog Dₚ, where the additional context information can include, for instance, a receipt 214B (or email) showing a booking of campsites at Yellowstone.

Depending on the training or fine-tuning of the third ML model 193C (see FIG. 2A), the response 213 can additionally, or alternatively, include a second follow-up message 215. The second follow-up message 215 can include one or more recommended entities and/or actions. For instance, as shown in FIG. 2B, the second follow-up message 215 can include a recommended national park (e.g., Grand Tenton) near Yellowstone, and/or one or more actions associated with the recommended entity of “Grand Tenton”. The one or more recommended actions can include, for instance, a first recommended action (e.g., book a stay at Grand Teton) and/or a second recommended action (e.g., book an activity at Grand Teton).

It is noted that, while the second prompt 209 is illustrated in FIG. 2B as being generated in response to the user query 201, the second prompt 209 is in fact not rendered to the user via the interface 200, but is provided to the third ML model 193C, for processing using the third ML model 193C. It is further noted that descriptions of the response 213 are not limited herein. For instance, in response to a spoken utterance of “I want to learn more about Cheetah” received via one or more microphones of a client device (e.g., 10 in FIG. 1), an additional user interface (e.g., different from 200 in FIG. 2B) of the assistant application 140 can be rendered, where the additional user interface can show the particular dialog Dₚ (or a final portion thereof) which shows discussions between the user and the assistant application about the particular topic Tₚ, i.e., “summer road trip” to Yellowstone.

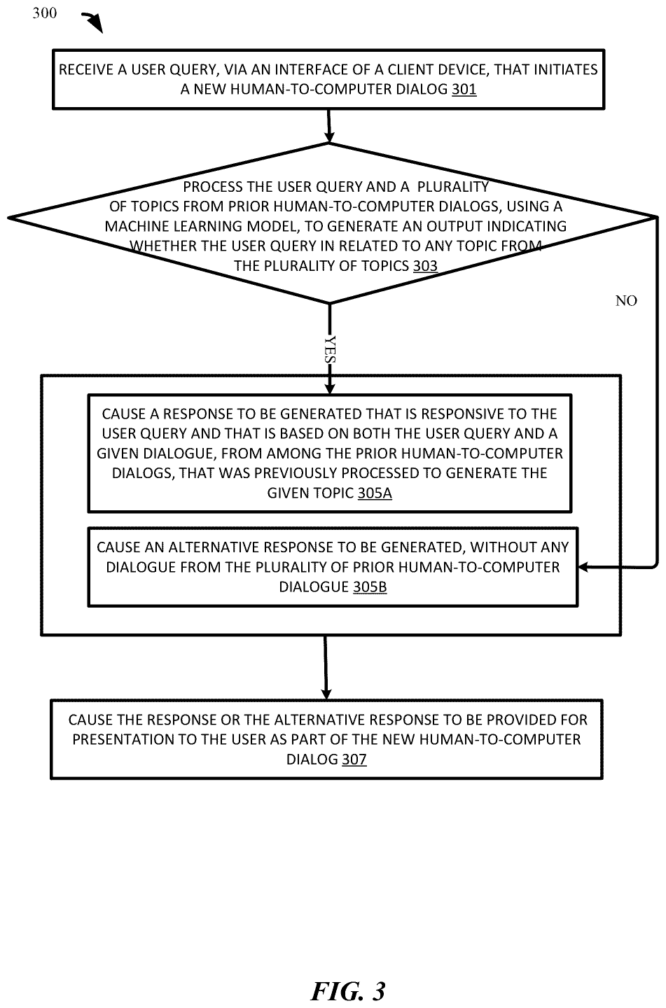

FIG. 3 depicts an example of a method for generating a response in accordance with various aspects of the present disclosure. A system for performing the method 300 includes one or more processors, memory, and/or other component(s) of computing device(s) (e.g., client computing device 10 of FIG. 1, one or more servers, and/or other computing devices). Moreover, while operations of the method 400B are shown in a particular order, this is not meant to be limiting. One or more operations may be reordered, omitted, and/or added.

In various implementations, at block 301, the system receives a user query, via an interface of a client device, that initiates a new human-to-computer dialog.

In various implementations, at block 303, in response to receiving the user query that initiates the new human-to-computer dialog, the system processes the user query and a plurality of topics from prior human-to-computer dialogs, using a machine learning model, to generate an output indicating whether the user query in related to any topic from the plurality of topics. The plurality of topics can be determined based on previously processing the prior human-to-computer dialogs.

In various implementations, at block 305A, in response to the output indicating that the user query is related to a given topic, from among the plurality of corresponding topics, the system can cause a response to be generated that is responsive to the user query and that is based on both the user query and a given dialog, from among the prior human-to-computer dialogs, that was previously processed to generate the given topic.

In various implementations, at block 305B, in response to the output indicating that the user query does not match any topic, from among the plurality of corresponding topics, the system can generate an alternative response responsive to the user query based on the user query, without any dialog from the plurality of prior human-to-computer dialogs that were previously processed to generate the plurality of corresponding topics.

In various implementations, at block 307, the system can cause the response or the alternative response to be provided for presentation to the user as part of the new human-to-computer dialog.

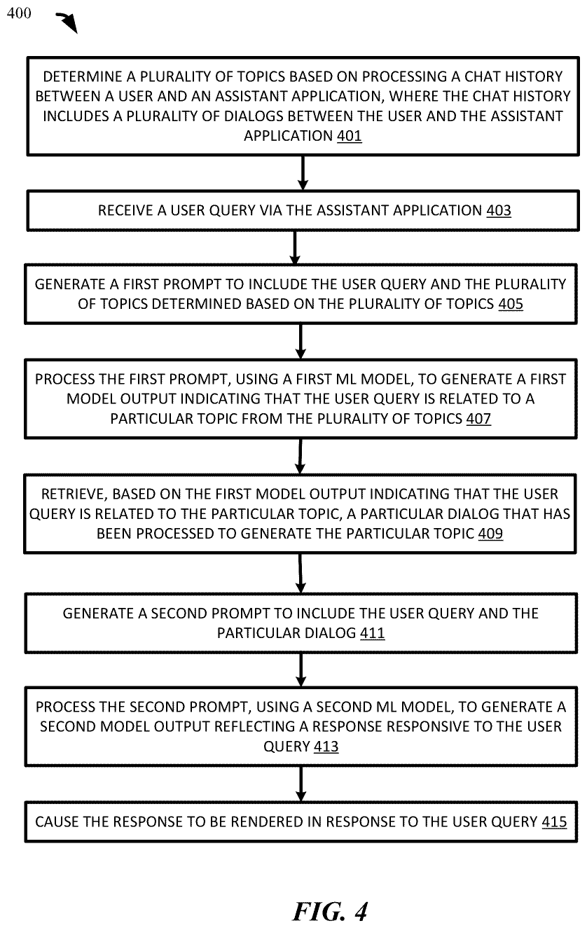

FIG. 4 depicts an example of a method for generating a response in accordance with various aspects of the present disclosure. A system for performing the method 400 includes one or more processors, memory, and/or other component(s) of computing device(s) (e.g., client computing device 10 of FIG. 1, one or more servers, and/or other computing devices). Moreover, while operations of the method 400B are shown in a particular order, this is not meant to be limiting. One or more operations may be reordered, omitted, and/or added.

In various implementations, at block 401, the system determines a plurality of topics based on processing a chat history between a user and an assistant application, where the chat history includes a plurality of dialogs between the user and the assistant application.

In various implementations, at block 403, the system receives a user query via the assistant application.

In various implementations, at block 405, the system generates a first prompt to include the user query and the plurality of topics determined based on the plurality of topics.

In various implementations, at block 407, the system processes the first prompt, using a first ML model, to generate a first model output indicating that the user query is related to a particular topic from the plurality of topics.

In various implementations, at block 409, the system retrieves, based on the first model output indicating that the user query is related to the particular topic, a particular dialog that has been processed to generate the particular topic.

In various implementations, at block 411, the system generates a second prompt to include the user query and the particular dialog.

In various implementations, at block 413, the system processes the second prompt, using a second ML model, to generate a second model output reflecting a response responsive to the user query.

In various implementations, at block 415, the system causes the response to be rendered in response to the user query.

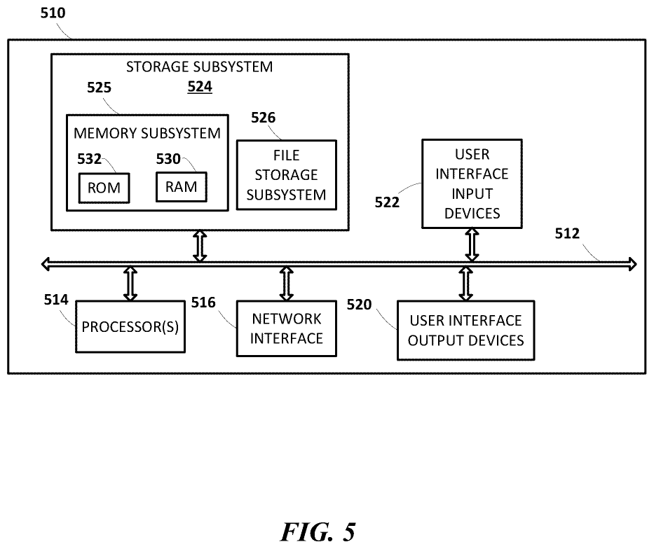

Turning now to FIG. 5, a block diagram of an example computing device 510 that may optionally be utilized to perform one or more aspects of techniques described herein is depicted. In some implementations, one or more of a client device, cloud-based LLM-based assistant component(s), and/or other component(s) may comprise one or more components of the example computing device 510.

Computing device 510 typically includes at least one processor 514 which communicates with a number of peripheral devices via bus subsystem 512. These peripheral devices may include a storage subsystem 524, including, for example, a memory subsystem 525 and a file storage subsystem 526, user interface output devices 520, user interface input devices 522, and a network interface subsystem 516. The input and output devices allow user interaction with computing device 510. Network interface subsystem 516 provides an interface to outside networks and is coupled to corresponding interface devices in other computing devices.

User interface input devices 522 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computing device 510 or onto a communication network.

User interface output devices 520 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 510 to the user or to another machine or computing device.

Storage subsystem 524 stores programming and data constructs that provide the functionality of some or all of the modules described herein. For example, the storage subsystem 524 may include the logic to perform selected aspects of the methods disclosed herein, as well as to implement various components depicted in FIG. 1.

These software modules are generally executed by processor 514 alone or in combination with other processors. Memory 525 used in the storage subsystem 524 can include a number of memories including a main random-access memory (RAM) 530 for storage of instructions and data during program execution and a read only memory (ROM) 532 in which fixed instructions are stored. A file storage subsystem 526 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 526 in the storage subsystem 524, or in other machines accessible by the processor(s) 514.

Bus subsystem 512 provides a mechanism for letting the various components and subsystems of computing device 510 communicate with each other as intended. Although bus subsystem 512 is shown schematically as a single bus, alternative implementations of the bus subsystem 512 may use multiple busses.

Computing device 510 can be of varying types including a workstation, server, computing cluster, blade server, server farm, or any other data processing system or computing device. Due to the ever-changing nature of computers and networks, the description of computing device 510 depicted in FIG. 5 is intended only as a specific example for purposes of illustrating some implementations. Many other configurations of computing device 510 are possible having more or fewer components than the computing device depicted in FIG. 5.

In situations in which the systems described herein collect or otherwise monitor personal information about users, or may make use of personal and/or monitored information), the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

Some other implementations disclosed herein recognize that training a generative model can require a significant quantity (e.g., millions) of training instances. Due to the significant quantity of training instances needed, many training instances will lack input and/or output properties that are desired when the generative model is deployed for utilization. For example, some training instance outputs for an LLM can be undesirably grammatically incorrect, undesirably too concise, undesirably too robust, etc. Also, for example, some training instance inputs for an LLM can lack desired contextual data such as user attribute(s) associated with the input, conversational history associated with the input, etc. As a result of many of the LLM training instances lacking desired input and/or output properties, the LLM will, after training and when deployed, generate many instances of output that likewise lack the desired output properties.

In addition, some implementations include one or more processors (e.g., central processing unit(s) (CPU(s)), graphics processing unit(s) (GPU(s), and/or tensor processing unit(s) (TPU(s)) of one or more computing devices, where the one or more processors are operable to execute instructions stored in associated memory, and where the instructions are configured to cause performance of any of the aforementioned methods. Some implementations also include one or more transitory or non-transitory computer readable storage media storing computer instructions executable by one or more processors to perform any of the aforementioned methods. Some implementations also include a computer program product including instructions executable by one or more processors to perform any of the aforementioned methods.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, and/or method described herein. In addition, any combination of two or more such features, systems, and/or methods, if such features, systems, and/or methods are not mutually inconsistent, is included within the scope of the present disclosure.

1. A computer-implemented method comprising:
identifying a plurality of prior human-to-computer dialogs stored in association with a user;
processing, using a first machine learning model, the plurality of prior human-to-computer dialogs respectively to determine a topic for each of the plurality of prior human-to-computer dialogs;
storing, in one or more databases, the topic for each of the plurality of prior human-to-computer dialogs; and
subsequent to determining the topic for each of the plurality of human-to-computer dialogs:
receiving a user query via an interface of a client device;
processing, using a second machine learning model, at least the user query and the topics determined from the plurality of human-to-computer dialogs to generate output that indicates whether the user query is related to a given topic from among the topics determined from the plurality of human-to-computer dialogs; and
in response to determining that the user query is related to the given topic:
causing a response to be generated that is responsive to the user query and that is based on both the user query and a given dialog, from among the prior human-to-computer dialogs, that is associated with the given topic; and
causing the response to be provided for presentation to the user as part of the new human-to-computer dialog.

2. The method of claim 1, wherein the first machine learning model is a generative model.

3. The method of claim 2, wherein the second machine learning model is an additional generative model having fewer parameters than the first generative model.

4. The method of claim 1, further comprising:
causing the given dialog, or a link to the given dialog, to be rendered with respect to the user query.

5. The method of claim 1, further comprising:
in response to the output indicating that the user query is not related to any topic from the topics determined from the plurality of human-to-computer dialogs,
processing the user query, using the first machine learning model or a third machine learning model, to generate an alternative model output indicating an alternative response responsive to the user query, and
causing the alternative response to be rendered in response to the user query.

6. The method of claim 1, further comprising:
detecting that the new human-to-computer starting with the user query comes to an end,
processing the new human-to-computer, using the first machine learning model, to generate an additional topic that summarizes the new human-to-computer, and
updating a topic list of the topics determined from the plurality of human-to-computer dialogs, to include the additional topic.

7. The method of claim 6, wherein processing the new human-to-computer to generate the additional topic that summarizes the new human-to-computer is in response to detecting that the new human-to-computer starting with the user query has come to an end and is response to the output indicating that the user query is not related to any topic from the determined topics.

8. The method of claim 1, wherein processing, using the second machine learning model, at least the user query and the topics determined from the plurality of human-to-computer dialogs comprises:
processing, using the second machine learning model, the user query, the topics, and one or more training examples.

9. The method of claim 8, wherein the one or more training examples include a first training example having a first portion that corresponds to a first example user query, a second portion corresponding to the topics or a list of different topics, and a third portion corresponding to an indication that indicates the first example user query is related to a particular topic, from the topics or the list of different topics.

10. The method of claim 1, wherein the output that indicates whether the user query is related to the given topic is one or more of: a one-hot vector, or a continuous vector.

11. A computer-implemented method, comprising:
receiving a user query, via an interface of a client device, that initiates a new human-to-computer dialog;
in response to receiving the user query that initiates the new human-to-computer dialog:
processing the user query and a plurality of topics determined from prior human-to-computer dialogs, using a machine learning model, to generate a output indicating whether the user query in related to any topic from the plurality of topics,
wherein the corresponding plurality of topics are determined based on previously processing the prior human-to-computer dialogs with an additional machine learning model; and
in response to the output indicating that the user query is related to a given topic, from among the plurality of corresponding topics:
causing a response to be generated that is responsive to the user query and that is based on both the user query and a given dialog, from among the prior human-to-computer dialogs, that was previously processed to generate the given topic;
causing the response to be provided for presentation to the user as part of the new human-to-computer dialog.

12. The method of claim 11, comprising:
in response to the output indicating that the user query is not related to any topic from the determined topics and in response to detecting one or more conditions being satisfied,
processing the new human-to-computer dialog starting with the user query, using a generative model, to generate an additional topic that summarizes the new human-to-computer dialog, and
storing the additional topic in association with the user of the user query, along with the plurality of topics.

13. The method of claim 12, wherein the one or more conditions include a first condition indicating whether the new human-to-computer dialog has come to an end.

14. The method of claim 12, wherein the one or more conditions include a second condition indicating a time of the day.

15. The method of claim 12, wherein the one or more conditions include a third condition indicating a battery level of the client device.

16. The method of claim 11, wherein processing the user query and a plurality of topics determined from prior human-to-computer dialogs comprises:
generating a first prompt to include the user query and the plurality of topics, and
processing the first prompt as input, using the machine learning model, to generate the output indicating whether the user query is related to any topic from the plurality of topics.

17. The method of claim 11, wherein the first prompt further includes one or more training examples.

18. The method of claim 17, wherein the one or more training examples include a first training example having a first portion that corresponds to a first example user query, a second portion corresponding to the topics or a list of different topics, and a third portion corresponding to an indication that indicates the first example user query is related to a particular topic, from the topics or the list of different topics.

19. The method of claim 18, wherein the indication is one or more of: a one-hot vector, a continuous vector, or a plurality of probabilities.

20. A system comprising one or more processors and a memory storing instructions that, when executed, cause one or more of the processors to:
receive a user query, via an interface of a client device, that initiates a new human-to-computer dialog;
in response to receiving the user query that initiates the new human-to-computer dialog:
process the user query and a plurality of topics determined from prior human-to-computer dialogs, using a machine learning model, to generate a output indicating whether the user query in related to any topic from the plurality of topics,
wherein the corresponding plurality of topics are determined based on previously processing the prior human-to-computer dialogs with an additional machine learning model; and
in response to the output indicating that the user query is related to a given topic, from among the plurality of corresponding topics:
cause a response to be generated that is responsive to the user query and that is based on both the user query and a given dialog, from among the prior human-to-computer dialogs, that was previously processed to generate the given topic;
cause the response to be provided for presentation to the user as part of the new human-to-computer dialog.
